(19) United States
(12) Patent Application Publication
(10) Pub. No.: US 2015/0323562 A1
(43) Pub. Date: Nov. 12, 2015

(54) MAGNETIC PROFILE MEASURING DEVICE AND METHOD FOR MEASURING MAGNETIC PROFILE FOR DIRECT-CURRENT (DC) MAGNETIC FIELD

(71) Applicant: Akita University, Akita-shi, Akita (JP)

(72) Inventors: Hitoshi SAITO, Akita-shi, Akita (JP); Satoru YOSHIMURA, Akita-shi, Akita (JP)

(21) Appl. No.: 14/347,407

(22) PCT Filed: Sep. 25, 2012
(86) PCT No.: PCT/JP2012/074599

§ 371 Date: Mar. 26, 2014

(30) Foreign Application Priority Data
Sep. 26, 2011 (JP) 2011-210008

(51) Int. Cl. G01Q 60/54; G01Q 30/04

(52) U.S. Cl. CPC G01Q 60/54; G01Q 30/04

(57) ABSTRACT

A magnetic profile measuring device which scans on a surface of a specimen by a magnetized probe on a tip of a driven cantilever, detects vibration of the cantilever, and generates a magnetic field distribution image of the area, the device including: the cantilever having the probe equipped on tip thereof; a driver driving the cantilever; an alternating-current magnetic field generator periodically reversing the magnetic polarity of the probe; a vibration sensor detecting vibration of the probe; a demodulator demodulating from a detection signal of the vibration sensor a magnetic signal corresponding to an alternating magnetic force between the probe and the specimen; a scanning mechanism; a data storage storing an initial data for each coordinate of the scanning area; a modified data generator generating a plurality of data by modifying the phase of the initial data; and an image display device.

### TECHNICAL FIELD

The present invention relates to a technique to measure a magnetic profile of a surface of a specimen generating a direct-current (DC) magnetic field by scanning an area on the surface of the specimen by means of a probe on a tip of a driven cantilever.

Specifically, the present invention relates to a magnetic profile measuring technique using, as an initial data, amplitude and a phase of the magnetic field obtained by scanning the scanning area, or α-component and β-component on Gauss plane, thereby making it possible to obtain an image of magnetic field distribution (a perpendicular magnetic field image and/or an in-plane magnetic field image) on the surface of the specimen generating a direct-current (DC) magnetic field.

### BACKGROUND ART

Conventionally, a magnetic force microscope (MFM) is known as a device to obtain a magnetic profile of a specimen.

MFM includes ones to observe alternating-current magnetic field (AC magnetic field) and ones to observe direct-current magnetic field (DC magnetic field).

Since the present invention is a technique related to the MFM to observe DC magnetic field, hereinafter a conventional technique of the MFM to observe DC magnetic field is described.

FIG. 7 is a figure to explain a conventional MFM to observe DC magnetic field in which a probe 811 of a cantilever 81 is made of a hard magnetic material (see Patent Document 1).

The hard magnetic material is a material which hardly cause magnetization reversal once the material is magnetized. In the MFM of FIG. 7, an alloy of cobalt and chrome, an alloy of iron and platinum or the like is employed for the probe 811.

In the MFM of FIG. 7, the cantilever 81 is driven by a piezoelectric element 812 at a resonant frequency of the cantilever or at a frequency close to the resonant frequency of the cantilever (for example, around 300 kHz).

When two-dimensional scanning is carried out on a surface of a specimen 82 by means of the probe 811 of the cantilever, a magnetic interaction occurs between the probe 811 and the specimen 82.

This magnetic interaction makes the cantilever 81 act as if its spring constant had changed while vibrating. This apparent change in the spring constant changes the resonant frequency of the cantilever 81. As the resonant frequency of the cantilever changes, amplitude and a phase of the cantilever also change.

In the MFM of FIG. 7, vibration whose amplitude and phase have been changed is measured by for example optical detection. This makes it possible to obtain a magnetic profile (for example, magnetic characteristics corresponding to recording state) of the specimen 82 as an image of magnetic field distribution.

### CITATION LIST

### Patent Literature

Patent Document 1: Japanese Patent Application Laid-Open No. 2003-65935 Patent Document 2: WO 2009/101991

### DISCLOSURE OF THE INVENTION

### Problems to be Solved by the Invention

Unfortunately, the MFM of FIG. 7 has drawbacks that its signal intensity is weak and it has a bad S/N ratio.

On the other hand, an MFM to observe DC magnetic field shown in FIG. 8 which employs a probe of soft magnetism as a prove 911 of a cantilever 91 has been applied for a patent by the present inventors (see Patent Document 2).

The MFM of FIG. 8 can mend the above drawbacks. In the MFM of FIG. 8, a material which causes a magnetization reversal under a comparatively weak outer magnetic field, such as nickel-iron Ni—Fe, is employed as the probe 911.

In the MFM of FIG. 8, an alternating-current magnetic field generator 92 is provided on the side of a specimen 93 opposite from the cantilever 91. This alternating-current magnetic field generator 92 does not affect magnetization state of a surface of the specimen 93, but it can change the direction of magnetization (magnetic moment) of the probe 911.

In the MFM of FIG. 8 as well, the cantilever 91 is driven by means of a piezoelectric element 912 at a resonant frequency of the cantilever or at a frequency close to the resonant frequency of the cantilever (for example, around 300 kHz).

Frequency of alternating-current magnetic field generated by the alternating-current magnetic field generator 92 can be 10 Hz to 1 kHz which makes magnetization reversal of the probe 911 easily occur. When the alternating-current magnetic field generator 92 is operated while the cantilever 91 is driven, magnetic polarity of the probe 911 on a tip of the cantilever 91 is changed. This change generates a non-resonant alternating magnetic force having a frequency different from the resonant frequency of the cantilever 91 between the probe 911 and the specimen 93.

When two-dimensional scanning is carried out on the surface of the specimen 93 by means of the probe 911, a non-resonant alternating magnetic interaction occurs between the probe 911 and the specimen 93.

This non-resonant alternating magnetic force cannot drive the cantilever 91 by itself. When the cantilever 91 is driven at a frequency around the resonant frequency of the cantilever by means of a piezoelectric element or the like while the non-resonant alternating magnetic force works, though, this non-resonant alternating magnetic force makes the cantilever 91 act as if its spring constant had changed. Because of this apparent change in the spring constant, a frequency modulation occurs in vibration of the cantilever 91.

On the other hand, when the cantilever 91 is driven at a frequency different from the resonant frequency of the cantilever 91 by means of a piezoelectric element or the like, an amplitude modulation as well as the frequency modulation in the vibration of the cantilever 91.

In the MFM of FIG. 8, the vibration modulated by frequency and amplitude is for example optically detected and demodulated by frequency (or by amplitude), then the amplitude and the phase of the vibration are measured, whereby it is made possible to obtain a magnetic profile (for example, magnetic characteristics corresponding to a recording state) of the specimen 93 as an image of magnetic field distribution.

In the MFM of FIG. 8, by detecting signals demodulated by frequency (or by amplitude) by means of a lock-in amplifier or the like with low noise, it is possible to measure the magnetic profile of the surface of the specimen 93 (for example, a magnetic recording medium such as a magnetic disk).

In the MFM of FIG. 8, in advance of the measurement of the magnetic profile of the surface of the specimen 93 described above, roughness of the surface can be detected by two-dimensional scanning by means of the probe contacting on the surface of the specimen 93. When measuring the magnetic profile, it is possible to keep a constant distance between the surface of the specimen 93 and the probe 911, utilizing the obtained information of roughness of the surface.

In measurement of the magnetic profile of the surface of the specimen 93, an alternating-current magnetic field is applied to the probe 911, whereby a non-resonant magnetic force having a frequency different from the resonant frequency of the cantilever 91 is caused between the cantilever 91 and the specimen 93.

Then assuming, as shown in FIG. 9A, that a perpendicular magnetization component of the probe (a component of magnetization of the probe in a direction perpendicular to a specimen surface (white arrow)) is synchronized with a phase of magnetic field in the direction perpendicular to the surface of the specimen 93, it can be decided, at a point of time when the magnetization of the probe 911 is perpendicular to the specimen surface, that perpendicular magnetic field component is maximum (i.e. in-plane magnetic field component is zero) when the amplitude of the demodulated signal is maximum, and that the perpendicular magnetic field component is zero (i.e. the in-plane magnetic field component is maximum) when the amplitude of the demodulated signal is zero.

Also assuming, as shown in FIG. 9B, that an in-plane magnetization component of the probe (a component of magnetization of the probe in a direction parallel to the specimen surface (white arrow)) is synchronized with a phase of magnetic field in a direction parallel to the surface of the specimen 93, it can be decided, at a point of time when the magnetization of the probe 911 is parallel to the surface of the specimen 93, that the in-plane magnetic field component is maximum (i.e. the perpendicular magnetic field component is zero) when the amplitude of the demodulated signal is maximum, and that the in-plane magnetic field component is zero (i.e. the perpendicular magnetic field component is maximum) when the amplitude of the demodulated signal is zero.

The magnetic profile of the specimen by the MFM shown in FIG. 8 is measured by means of a lock-in amplifier with a signal source (current source) of the alternating-current magnetic field generator 92 as a reference signal.

In FIG. 9A, the perpendicular magnetization component (the component of magnetization of the probe in a direction perpendicular to the surface of the specimen 93) is synchronized with the phase of alternating-current magnetic field generated by the alternating-current magnetic field generator that generates the magnetic field perpendicular to the surface of the specimen 93. In this case, at a point of time when the magnetization of the probe 911 is perpendicular to the surface of the specimen 93, the perpendicular magnetic field component is maximum (i.e. the in-plane magnetic field component is zero) when the amplitude of the demodulated signal is maximum, and the perpendicular magnetic field component is zero (i.e. the in-plane magnetic field component is maximum) when the amplitude of the demodulated signal is zero.

Also, in FIG. 9B, the in-plane magnetization component of the probe 911 (a component of magnetization of the probe 911 in a direction parallel to the specimen surface) is synchronized with the phase of the alternating-current magnetic field generated by the alternating-current magnetic field generator that generates a magnetic field in a direction parallel to the surface of the specimen 93. In this case, when the magnetization of the probe 93 is parallel to the surface of the specimen 93, the in-plane magnetic field component is maximum (i.e. the perpendicular magnetic field component is zero) when the amplitude of the demodulated signal is maximum, and the in-plane magnetic field component is zero (i.e. the perpendicular magnetic field component is maximum) when the amplitude of the demodulated signal is zero.

However, in measuring the magnetic profile, the phase of the measurement signal may delay inside of the electric circuit of the alternating-current magnetic field generator on the side of the power source or inside of the electric circuit of the demodulator.

Further, change of the magnetization of the probe 911 may delay more than the delay in the change of the magnetic field of the alternating-current magnetic field generator, resulting in a further delay in the phase.

Since the delay in the phase shifts the timing of the time-dependent change of magnetization of the probe 911, when the phase delay occurs, the magnetization of the probe 911 does not become perpendicular to the surface of the specimen 93 in the synchronizing signal output of the lock-in amplifier, which makes it impossible to measure the perpendicular magnetic field component alone.

Also, where a phase delay occurs in the orthogonal signal output of the lock-in amplifier, the magnetization of the probe 911 does not become parallel to the surface of the specimen 93, which makes it impossible to measure the in-plane magnetic field component alone.

The object of the present invention is to provide a magnetic profile measuring technique which makes it possible to obtain a perpendicular magnetic field image, in-plane magnetic field image, or an synthesized magnetic field image of the perpendicular magnetic field and the in-plane magnetic field, depending on phase change, using image data of magnetic field distribution obtained for the specimen that generates a direct-current (DC) magnetic field.

Another object of the present invention is to provide a magnetic profile measuring technique which makes it possible to obtain an in-plane magnetic field image that does not include a perpendicular magnetic field component and a perpendicular magnetic field image that does not include an in-plane magnetic field component, using image data of magnetic field distribution obtained for the specimen that generates a direct-current (DC) magnetic field.

### Means for Solving the Problems

The present inventors made the present invention based on the finding that even from an image of perpendicular magnetic field distribution having an indefinite phase, the image being obtained from a perpendicular magnetic field component perpendicular to a surface of the specimen and an in-plane magnetic field component parallel to the surface of the specimen, it is possible to obtain, by adjusting the phase, an image of magnetic field distribution having a desired phase unaffected by phase delay of measurement signal inside of signal processing circuit or phase delay of magnetic field generated by an alternating-current magnetic field generator.

A magnetic profile measuring device of the present invention has following embodiments.

(1)

A magnetic profile measuring device which scans a scanning area on a surface of a specimen by means of a magnetized probe on a tip of a driven cantilever, detects vibration of the cantilever, and generates an image of magnetic field distribution of the scanning area based on results of the detection, the device including:

the cantilever wherein the probe is equipped on the tip of the cantilever;

a driver driving the cantilever at a resonant frequency of the cantilever or at a frequency close to the resonant frequency of the cantilever;

an alternating-current magnetic field generator generating an alternating-current magnetic field and periodically reversing the magnetic polarity of the probe, and thereby modulating driven vibration of the cantilever by frequency or by both frequency and amplitude;

a vibration sensor detecting vibration of the probe;

a demodulator demodulating from a detection signal of the vibration sensor a magnetic signal which corresponds to an alternating magnetic force occurring between the probe and the specimen, and detecting the demodulated magnetic signal as (A) two separate signal components having phase difference of 90° and being orthogonal to each other or (B) amplitude and a phase of the magnetic field at the position of the probe;

a scanning mechanism scanning the scanning area by means of the probe;

a data storage storing an initial data for each coordinate of the scanning area wherein the initial data is (A) the two separate signal components orthogonal to each other or (B) the amplitude and phase of the magnetic field, and wherein the initial data is obtained by scanning the scanning area by means of the scanning mechanism on condition that the demodulation is synchronized with operation of the alternating-current magnetic field generator;

a modified data generator recalling the initial data from the data storage and generating a plurality of data by modifying the phase of the initial data; and

an image display device displaying an image of magnetic field distribution based on data generated for each coordinate of the scanning area by the modified data generator.

(2)

The magnetic profile measuring device according to (1), wherein

where the magnetic field at the position of the probe is represented by

H_{α}+jH_{β}≡H₀exp(j(φ)

in α-β complex plane which is Gauss plane;

amplitude of the magnetic field at the position of the probe, H₀, is represented by

H₀≡(H_{α}²+H_{β}²)^{1/2}

which is a distance from the origin in the α-β complex plane;

the phase of the magnetic field at the position of the probe, φ, is represented by

φ≡tan⁻¹(H_{β}/H_{α})

which is an argument φ in the α-β complex plane;

α-component of the magnetic field at the position of the probe is represented by

H_{α}≡H₀ cosφ

which is a component parallel to the α-axis; and

β-component of the magnetic field at the position of the probe is represented by

H_{β}≡H₀ cosφ

which is a component parallel to the β-axis perpendicular to the a-axis, the demodulator detects the demodulated magnetic signal as (A) a data pair of the α-component and the β-component (H_{α}, H_{β}) or (B) a data pair of the amplitude and the phase (H₀, φ).

(3)

The magnetic profile measuring device according to (2), wherein either (X) the α-component is a perpendicular magnetic field component of the magnetic field wherein the perpendicular magnetic field component is a component perpendicular to the surface of the specimen; and the β-component is an in-plane magnetic field component of the magnetic field wherein the in-plane magnetic field component is a component parallel to the surface of the specimen,

or (Y) the α-component is an in-plane magnetic field component of the magnetic field wherein the in-plane magnetic field component is a component parallel to the surface of the specimen; and the β-component is a perpendicular magnetic field component of the magnetic field wherein the perpendicular magnetic field component is a component perpendicular to the surface of the specimen.

(4)

The magnetic profile measuring device according to (2) or (3), wherein the magnetic field at the position of the probe is displayed by means of the image display device by making the α-component and/or the β-component into an image depending on variation of the argument φ.

(5)

A method for measuring magnetic profile including scanning a scanning area on a surface of a specimen by means of a magnetized probe on a tip of a driven cantilever, detecting vibration of the cantilever, and generating an image of magnetic field distribution of the scanning area based on results of the detection, the method including the steps of:

driving the cantilever at a resonant frequency of the cantilever or at a frequency close to the resonant frequency of the cantilever, wherein the probe is equipped on the tip of the cantilever (S110);

generating an alternating-current magnetic field and periodically reversing the magnetic polarity of the probe, and thereby modulating driven vibration of the cantilever by frequency (S120);

detecting vibration of the probe and demodulating from the detection signal a magnetic signal which corresponds to an alternating magnetic force occurring between the probe and the specimen (S130);

detecting the demodulated magnetic signal as (A) two separate signal components which have phase difference of 90° and are orthogonal to each other or (B) amplitude and a phase of the magnetic field at the position of the probe (S140);

scanning the scanning area by means of the probe (S150);

storing an initial data in a data storage for each coordinate of the scanning area wherein the initial data is (A) the two separate signal components orthogonal to each other or (B) the amplitude and phase of the magnetic field, and wherein the initial data is obtained by scanning the scanning area on condition that the demodulation is synchronized with the generation of the alternating-current magnetic field (S160);

recalling the initial data from the data storage and generating a plurality of data by modifying the phase of the initial data (S170);

displaying an image of a magnetic field distribution based on data generated by modifying the phase of the initial data, on an image display device (S180); and

measuring the magnetic profile of the specimen based on each image of magnetic field distribution displayed on the image display device (S190).

(6)

The method for measuring magnetic profile according to (5), wherein in the step of detecting the demodulated magnetic signal (S140), where the magnetic field at the position of the probe is represented by

H_{α}+jH_{β}≡H₀exp(jφ)

in α-β complex plane which is Gauss plane;

amplitude of the magnetic field at the position of the probe, H₀, is represented by

H₀≡(H_{α}²+H_{β}²)^{1/2}

which is a distance from the origin in the α-β complex plane;

the phase of the magnetic field at the position of the probe, φ, is represented by

φ≡tan⁻¹(H_{β}/H_{α})

which is an argument φ in the α-β complex plane;

α-component of the magnetic field at the position of the probe is represented by

H_{α}≡H₀ cosφ

which is a component parallel to the α-axis; and

β-component of the magnetic field at the position of the probe is represented by

H_{β}≡H₀ cosφ

which is a component parallel to the β-axis perpendicular to the α-axis,

the demodulated magnetic signal is detected as (A) a data pair of the α-component and the β-component (H_{α}, H_{β}) or (B) a data pair of the amplitude and the phase (H₀, φ)

(7)

The method for measuring magnetic profile according to (6), wherein

either (X) the α-component is a perpendicular magnetic field component of the magnetic field wherein the perpendicular magnetic field component is a component perpendicular to the surface of the specimen; and the β-component is an in-plane magnetic field component of the magnetic field wherein the in-plane magnetic field component is a component parallel to the surface of the specimen,

or (Y) the α-component is an in-plane magnetic field component of the magnetic field wherein the in-plane magnetic field component is a component parallel to the surface of the specimen; and the β-component is a perpendicular magnetic field component of the magnetic field wherein the perpendicular magnetic field component is a component perpendicular to the surface of the specimen.

(8)

The method for measuring magnetic profile according to (6) or (7),

wherein the magnetic field at the position of the probe is displayed by means of the image display device by making the α-component and/or the β-component into an image depending on variation of the argument φ.

### Effects of the Invention

The present invention makes it possible to obtain an image of perpendicular magnetic field of specimen that does not include an in-plane magnetic field component and to obtain an image of in-plane magnetic field of specimen that does not include a perpendicular magnetic field component, using an obtained image data of magnetic field distribution.

In other words, in measuring magnetic profile of a specimen by MFM, perpendicular magnetic field component and in-plane magnetic field component may overlap, but the present invention makes it possible to mend or resolve this overlap of magnetic field components.

This makes it possible to separate a magnetic field component observed at a measurement point into a perpendicular magnetic field component and an in-plane magnetic field component.

### BRIEF DESCRIPTION OF THE DRAWINGS

FIG. 1 is a figure to explain an embodiment of a magnetic profile measuring device of the present invention;

FIG. 2 is a flowchart showing an embodiment of a method for measuring magnetic profile of the present invention;

FIG. 3 is a figure illustrating an embodiment of the magnetic profile measuring device of the present invention and processes of an embodiment of the method for measuring magnetic profile of the present invention, as well as a figure for supplementary explanation illustrating a phase before modified data generating process is carried out by a modified data generator;

FIG. 4 is a figure illustrating an embodiment of the magnetic profile measuring device of the present invention and processes of an embodiment of the method for measuring magnetic profile of the present invention, as well as a figure for supplementary explanation illustrating a phase before modified data generating process is carried out by a modified data generator;

FIG. 5A is an image of perpendicular magnetic field distribution having an indefinite phase stored in a data storage, and FIG. 5B is an example image of in-plane magnetic field distribution having an indefinite phase stored in the data storage;

FIG. 6 provides synthesized images of perpendicular magnetic field distribution images and in-plane magnetic field distribution images made from images of FIGS. 5A and 5B (data stored in the data storage 17), which synthesized images show examples of magnetic field distribution images each having an adjusted phase;

FIG. 7 is a figure to explain a conventional MFM to observe DC magnetic field in which a probe of a cantilever is a probe with hard magnetic properties;

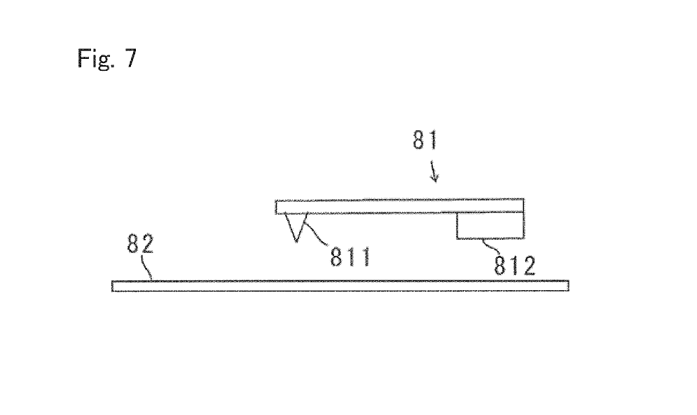

FIG. 8 is a figure to explain a conventional MFM to observe DC magnetic field in which a probe of a cantilever is a probe with soft magnetic properties;

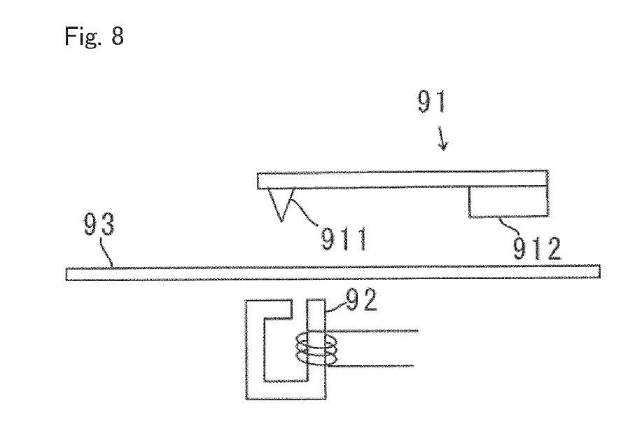

FIG. 9 includes figures to explain operation of the MFM of FIG. 8; FIG. 9A is a figure illustrating a case where a perpendicular magnetization component of the probe (a component of magnetization of the probe in a direction perpendicular to the specimen surface) is synchronized with a phase of magnetic field in a perpendicular direction of the specimen surface, and FIG. 9B is a figure illustrating a case where an in-plane magnetization component of the probe (a component of magnetization of the probe in a direction parallel to the specimen surface) is synchronized with a phase of magnetic field in a parallel direction to the specimen surface.

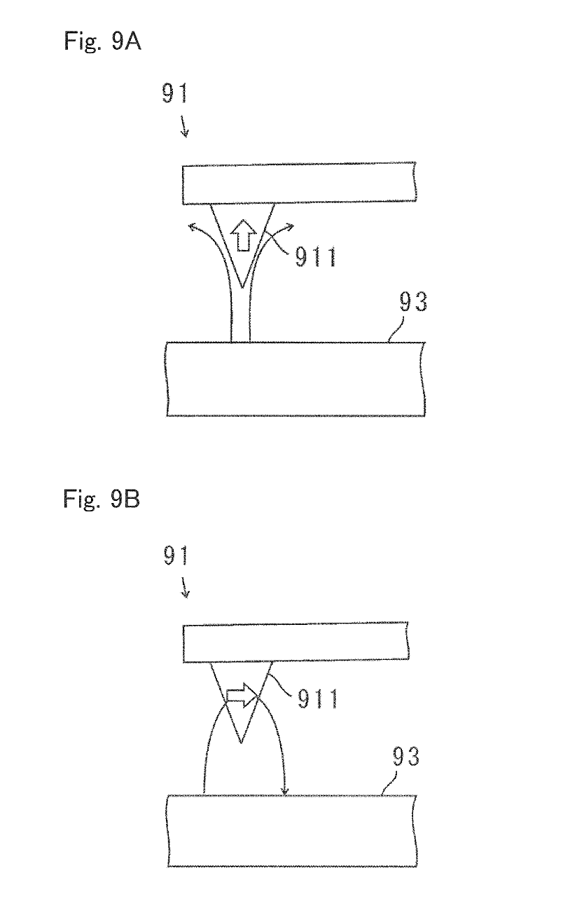

### MODES FOR CARRYING OUT THE INVENTION

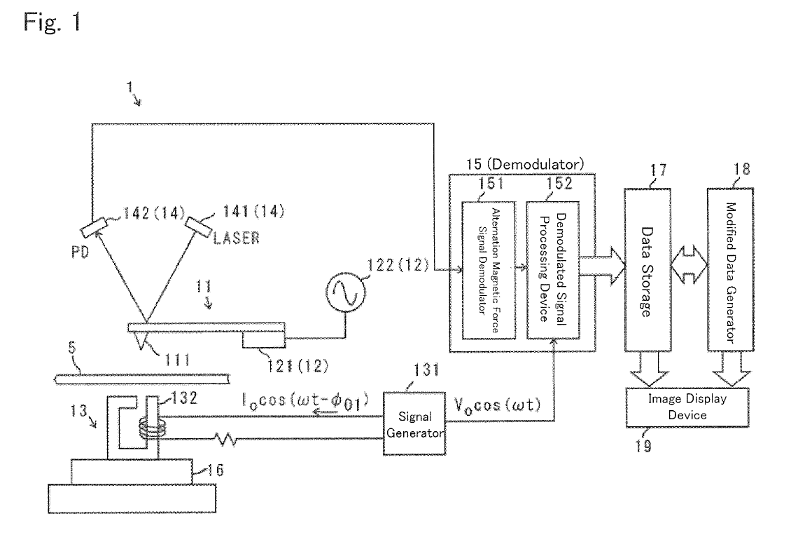

FIG. 1 is a figure to explain an embodiment of the magnetic profile measuring device of the present invention.

In FIG. 1, a magnetic profile measuring device 1 includes a cantilever 11, a driver 12, an alternating-current magnetic field generator 13, a vibration sensor 14, a demodulator 15, a scanning mechanism 16, a data storage 17, a modified data generator 18, and an image display device 19. The magnetic profile measuring device 1 can scan a scanning area on a surface of a specimen 5 by means of a magnetized probe 111 on a tip of the driven cantilever 11, detect vibration of the cantilever 11, and generate an image of magnetic field distribution of the scanning area based on results of the detection with following configuration.

The cantilever 11 has the probe 111 on its tip. The probe 111 is formed in a cone shape in this embodiment, and a film made of a so-called soft magnetic material is formed on a surface of the probe 111. The film made of the soft magnetic material is magnetized via the specimen 5 by a magnetic field from the alternating-current magnetic field generator 13, but magnetization state of the specimen 5 is not affected by the magnetic field.

The driver 12 is composed of a piezoelectric element 121 and a power source 122. The power source 122 drives the piezoelectric element 121, which drives the cantilever 11. The driver 12 drives the cantilever 11 at a resonant frequency of the cantilever 11 or at a frequency close to the resonant frequency of the cantilever 11 (in the present invention, the resonant frequency of the cantilever and a frequency close to the resonant frequency of the cantilever are referred to as “carrier frequency”). In this embodiment, the carrier frequency can be for example 300 kHz.

The alternating-current magnetic field generator 13 is, in this embodiment, a small electromagnet including a coil and provided on the opposite side of the specimen 5 from the cantilever 11. That is, the alternating-current magnetic field generated by the alternating-current magnetic field generator 13 works on the probe 111 through the specimen 5, and the direction of magnetization (magnetic moment) of the probe 111 changes periodically. Because of this, driven vibration of the cantilever 11 is modulated by frequency by an alternating-current magnetic force which occurs between the probe 11 and the specimen 5. Frequency of the magnetic field generated by the alternating-current magnetic field generator 13 can be around 10 Hz to 1 kHz for example. As described above, the magnetic field generated by the alternating-current magnetic field generator 13 has intensity such that the magnetization state of the specimen is not affected.

The vibration sensor 14 includes a laser 141 and a photodiode (PD) 142, and detects vibration of the probe 111 on the tip of the cantilever 11.

The demodulator 15 includes an alternating magnetic force signal demodulator 151 and a demodulated signal processing device 152. The alternating magnetic force signal demodulator 151 demodulates (by frequency or by amplitude) from a detection signal of the vibration sensor 14 the modulated probe vibration caused by the alternating magnetic force occurring between the probe 111 and the specimen 5.

The demodulated signal processing device 152 is, in specific, a lock-in amplifier, and detects from the demodulated alternating magnetic force an in-phase component H_{α} and an orthogonal component H_{β} wherein the component H_{α} is synchronized with a reference signal of the lock-in amplifier for a magnetic field at the position of the probe, and the component H_{β} has a phase difference of 90° from the reference signal, or has amplitude H₀ and a phase φ of the magnetic field.

Detecting the in-phase component H_{α} and the orthogonal component H_{β} of the lock-in amplifier for the magnetic field of each coordinate of the scanning area is equivalent to detecting the amplitude H₀ and the phase φ of the magnetic field.

The demodulated magnetic signal can be separated into a perpendicular magnetic field component perpendicular to a surface of the specimen 5 and an in-plane magnetic field component parallel to the surface of the specimen 5, by a modulated data generating process described later.

The scanning mechanism 16, moving on the specimen 5, scans the scanning area on the surface of the specimen 5 by means of the probe 111. The scanning mechanism 16 also can be configured to move the cantilever 11. Scanning speed of the scanning mechanism 16 is slow enough to be ignored when the demodulator 15 demodulates the alternating magnetic force.

The data storage 17 stores, as an initial data, the in-phase component H_{α} and the orthogonal component H_{β} of the lock-in amplifier for the magnetic field of each coordinate of the scanning area, or the amplitude H₀ and the phase φ of the magnetic field of the lock-in amplifier, wherein each component is obtained by scanning the scanning area by means of the scanning mechanism 16. Storing the in-phase component H_{α} and the orthogonal component H_{β} of the lock-in amplifier for the magnetic field of each coordinate of the scanning area as the initial data is equivalent to storing the amplitude H₀ and the phase φ of the magnetic field as the initial data.

The modulated data generator 18 recalls the initial data of the in-phase component H_{α} and the orthogonal component H_{β} of the lock-in amplifier for the magnetic field of each coordinate of the scanning area from the data storage 17 (or each data of the amplitude H₀ and the phase φ of the magnetic field).

The modulated data generator 18 generates, for each coordinate of the scanning area and for the in-phase component H₀, and the orthogonal component H_{β} of the lock-in amplifier for the magnetic field, a plurality of data pairs of a component parallel to α-axis of α-β complex plane (α-component) and a component parallel to β-axis perpendicular to the α-axis (β-component) in the α-β complex plane, wherein the amplitude H₀ is fixed and the phase φ is modulated (increased or decreased).

The image display device 19 displays an image of magnetic field distribution based on the initial data for each coordinate of the scanning area stored in the data storage 17 and an image of magnetic field distribution based on data for each coordinate of the scanning area generated by the modulated data generator 18.

In advance of the measurement of the magnetic profile of the specimen 5, roughness of the surface of the specimen 5 can be measured and stored. Thereafter the magnetic profile of the specimen 5 can be measured while a constant distance is kept between the probe 111 and the surface of the specimen 5. Measurement of the roughness of the surface of the specimen 5 may be carried out by contacting the probe 111 of the cantilever 11 to the surface of the specimen 5.

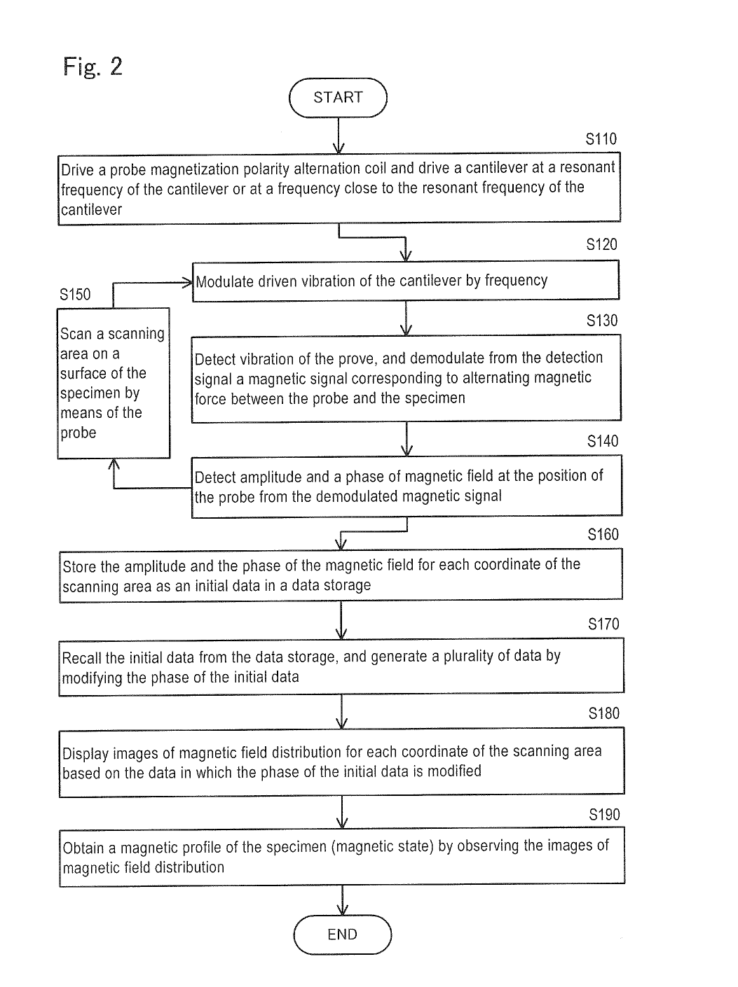

FIG. 2 is a flowchart showing an embodiment of the method for measuring the magnetic profile of the present invention.

Since the method for measuring the magnetic profile of FIG. 2 is carried out by means of the magnetic profile measuring device 1 of FIG. 1, operation of the magnetic profile measuring device 1 of FIG. 1 will be mainly explained referring to the flowchart of FIG. 2 in the following.

In FIG. 1, the power source 122 of the driver 12 drives the piezoelectric element 121 and drives the cantilever 11 at the resonant frequency of the cantilever 11 or at a frequency close to the resonant frequency of the cantilever 11 (carrier frequency) (S110). Comparing with “signal” and “carrier” of frequency modulation in communication systems, the alternating-current magnetic field corresponds to the “signal” (frequency of the signal is, in this embodiment, around 10 Hz to 1 kHz) and mechanical driving of the cantilever 11 by the piezoelectric element 121 corresponds to the “carrier” (frequency of the carrier is for example 300 kHz).

In FIG. 1, the alternating-current magnetic field generator 13 includes a signal generator 131 and a coil main body 132 (a small electromagnet including a coil) as described above. The signal generator 131 drives the coil main body 132 by an alternating-current voltage V represented by Formula (1):

V=V₀ cos(ωt) (1)

V₀ in Formula (1) is the amplitude of the alternating-current voltage, and its initial phase is zero. The alternating-current voltage V applies current I represented by Formula (2) to the winding of the coil main body 132:

I=I₀ cos(ωt−φ₀₁) (2)

I₀ in Formula (2) is the amplitude of alternating current.

Also, a delay angle φ₀₁ derives from resistance, inductance etc. of a circuit composing the alternating-current magnetic field generator 13.

By the current I° of Formula (2), the alternating-current magnetic field generator 13 generates a magnetic field in a direction perpendicular to the surface of the specimen 5 (perpendicular magnetic field component H_{V}):

H_{V}=H₀ cos(ωt−φ₀₂) (3)

H₀ in Formula (3) is the amplitude of the alternating-current magnetic field. The magnetic field in perpendicular direction (the perpendicular magnetic field component H_{V}) becomes maximum, a delay time of φ₀₂/6) after the alternating-current voltage V (see Formula (1)) of the signal generator 131. Herein, a delay angle φ₀₂ is an angle which is a sum of a delay angle φ_{dA}) in the alternating-current magnetic field generator 13 and the delay angle φ₀₁ in Formula (2).

The delay angle φ_{dA} is an angle caused by a delay in magnetization response that occurs when the alternating-current magnetic field is applied to a magnetic core material of the coil of the alternating-current magnetic field generator 13 etc.

As described above, the magnetic field from the alternating-current magnetic field generator 13 magnetizes the probe 111 having a soft magnetic material, without changing the magnetization state of the specimen 5, resulting in the magnetic moment of the probe 111 having a magnetization component rotating and repeatedly reversing by the alternating-current magnetic field from the alternating-current magnetic field generator 13.

Thus the alternating magnetic force occurring between the probe 111 and the specimen 5 can modulate driven vibration of the cantilever 11 by frequency (S120).

The vibration sensor 14 irradiates a laser beam from a laser 141 to an upper surface of the tip of the cantilever 11 to detect its reflected light by a photodiode 142, thereby detecting the vibration of the probe 111. The alternating magnetic force signal demodulator 151 demodulates from detection signal of the vibration sensor 14 the alternating magnetic force in a direction perpendicular to the surface of the specimen 5 (alternating magnetic force signal) caused by the alternating-current magnetic field at the position of the probe (S130).

Output F of the alternating magnetic force signal demodulator 151 is represented by Formula (4):

F=F₀ cos(ωt−φ₀₃) (4)

F₀ in Formula (4) is the amplitude of the alternating magnetic force, and a delay angle φ₀₃ is an angle which is a sum of a delay caused when a delay in magnetization response of the soft magnetic material composing the probe 111 to applied magnetic field etc., a delay caused when a delay in detection circuit of the vibration sensor 14 etc. occurs (these delays are defined as φ_{dB}), and the delay angle φ₀₂ in Formula (3). Herein, when the frequency of the magnetic field generated by the alternating-current magnetic field generator 13 is low, φ₀₃ becomes almost equal to φ₀₂.

The demodulated signal processing device 152 (lock-in amplifier) detects amplitude (F₀) and a phase (−φ₀₃) of the alternating magnetic force signal F demodulated by the alternating magnetic force signal demodulator 151 (S140).

The demodulated alternating magnetic force signal F is represented by Formula (5):

F₀ cos(ωt−φ₀₃)=F₀ cos(−φ₀₃)cos(ωt)−F₀ sin(−φ₀₃)sin(ωt)=F₀ cos(−φ₀₃)cos(ωt)+F₀ sin(−ω₀₃)cos(ωt+π/2) (5)

The demodulated signal processing device 152 separates the demodulated alternating magnetic force signal F into

F₀ cos(−φ₀₃)cos(ωt) (6A)

and

F₀ sin(−φ₀₃)cos(ωt+π/2) (6B).

Formula (6A), F₀ cos(−φ₀₃) cos(ωt) corresponds to the component of the magnetic field perpendicular to the surface of the specimen 5 (perpendicular magnetic field component) which becomes maximum with a delay of the phase angle φ₀₃ in magnetization of the probe 111 from the voltage (having an initial phase of zero) of the alternating-current magnetic field generator 13.

Also, Formula (6B), F₀ sin(−φ₀₃) cos(ωt+π/2) corresponds to the component of the magnetic field parallel to the surface of the specimen 5 (in-plane magnetic field component) which becomes maximum with a delay of further 90° of phase angle in magnetization of the probe 111.

Herein, value of the above (203 can be obtained by, using a standard specimen whose magnetization state is known such as a perpendicular magnetic recording medium having a low recording density, and carrying out phase adjustment at a position where only a perpendicular magnetic field occurs or a position where only an in-plane perpendicular magnetic field occurs.

Herein, defining a direction perpendicular to the specimen surface as z-direction, a direction parallel to the specimen surface as x-direction, a component of magnetization m of the probe 111 in a direction perpendicular to the specimen surface as m and a component of magnetization m of the probe 111 in a direction parallel to the specimen surface as mₓ, the probe magnetization varies due to magnetic field H of Formula (3) generated by the alternating-current magnetic field generator, and can be represented by Formula (7), or Formulae (7A) and (7B):

m=m₀exp(j(ωt−φ₀₄))=m_{z}jmₓ (7)

m_{z}=m₀ cos(ωt−φ₀₄) (7A)

mₓ=m₀ sin(ωt−φ₀₄) (7B)

The angle φ₀₄ in Formulae (7A) and (7B) is a delay angle which is a sum of a delay in magnetization response of the soft magnetic material composing the probe 111 to applied magnetic field etc. (defined as φ_{dc}) and the delay angle φ₀₂ in Formula (2). Herein, when the frequency of the magnetic field generated by the alternating-current magnetic field generator 13 is low, φ₀₄ becomes almost equal to φ₀₂.

An alternating magnetic force F, which is applied to the probe 111 from the specimen 5 and is perpendicular to the surface of the specimen 5 can be represented by Formula (8):

$$\begin{matrix}{F}_{z} = {m}_{x} ( \frac{\partial {H}_{z}}{\partial x} ) + {m}_{z} ( \frac{\partial {H}_{z}}{\partial z} ) \\ = {m}_{x} ( \frac{\partial {H}_{z}}{\partial z} ) + {m}_{z} ( \frac{\partial {H}_{z}}{\partial z} ) \\ = {m}_{0} sin ( ω t - {ϕ}_{04} ) ( \frac{\partial {H}_{x}}{\partial z} ) + {m}_{0 } cos ( ω t - {ϕ}_{04} ) ( \frac{\partial {H}_{z}}{\partial z} ) \\ = {m}_{0} \{ sin ( ω t ) cos ( - {ϕ}_{04} ) + cos ( ω t ) sin ( - {ϕ}_{04} ) \} ( \frac{\partial {H}_{x}}{\partial z} ) \\ + {m}_{0} \{ cos ( ω t ) cos ( - {ϕ}_{04} ) - sin ( ω t ) sin ( - {ϕ}_{04} ) \} ( \frac{\partial {H}_{z}}{\partial z} )\end{matrix} \qquad ( 8 )$$

Herein, since the magnetic field from the specimen 5 is an irrotational field generated by magnetic poles, a relationship represented by Formula (9) is satisfied:

(∂H_{z}/∂x)=(∂Hₓ/∂z) (9)

By the alternating magnetic force F, which is applied to the probe 111 from the specimen 5 and is perpendicular to the surface of the specimen 5, spring constant of the probe vibration effectively changes by (∂F_{z}/∂z), and frequency modulation occurs in proportion to the effective change of the spring constant.

That is, the demodulated signal corresponds to:

m₀{sin(ωt)cos(−φ₀₄)+cos(ωt)sin(−φ₀₄)}(∂²Hₓ/∂z²)+m₀{cos(ωt)cos(−φ₀₄)−sin(ωt)sin(−φ₀₄)}(∂²H_{z}/∂z²)

Also, a synchronizing signal measured by the demodulated signal processing device 152 (lock-in amplifier) corresponds to:

(∂²H_{z}/∂z²)m₀ cos(−φ₀₄)+(∂²Hₓ/∂z²)m₀ sin(−φ₀₄)

and an orthogonal signal measured by the demodulated signal processing device 152 corresponds to:

(∂²H_{z}/∂z²)m₀ cos(−φ₀₄)−(∂²Hₓ/∂z²)m₀ sin(−φ₀₄)

Therefore, the synchronizing signal measured by the demodulated signal processing device 152 corresponds to:

(∂²H_{z}/∂z²)cos(−φ₀₄)+(∂²Hₓ/∂z²)sin(−φ₀₄)

which is a sum of a gradient of perpendicular magnetic field and a gradient of in-plane magnetic field, and the orthogonal signal corresponds to:

−(∂²Hₓ/∂z²)sin(−φ₀₄)+(∂²H_{z}/∂z²)cos(−φ₀₄)

which is a sum of the gradient of in-plane magnetic field and the gradient of perpendicular magnetic field.

Herein, when the distance between the probe 111 and the specimen 5 is smaller than the magnetic moment length of the magnetization m, the component m, of the magnetization m of the probe 111 in a direction perpendicular to the surface of the specimen acts as a magnetic pole q formed on the tip of the probe, and the synchronizing signal measured by the demodulated signal processing device 152 (lock-in amplifier) corresponds to:

(∂aH_{z}/∂z)q cos(−φ₀₄)+(∂²Hₓ/∂z²)m₀ sin(−φP₀₄)

which is a sum of the gradient of perpendicular magnetic field and the gradient of in-plane magnetic field.

As will be described below, by adding φ₀₄ as a phase adjustment value φ_{C} to the phase delay −φ₀₄ and thereby making the initial phase zero, it is possible to obtain the synchronizing signal including the gradient of perpendicular magnetic field only, and the orthogonal signal including the gradient of in-plane magnetic field only.

Next, a case in which the cantilever 11 is inclined by θ will be described. Output (∂F/∂z) of the alternating magnetic force signal demodulator 151 in this case can be represented by Formula (10):

$$\begin{matrix}( \frac{\partial F}{\partial z} ) = [ \frac{\partial ( {F}_{z} cos ( θ ) + {F}_{x} sin ( θ ) )}{\partial z} ] \\ = [ \frac{\partial \{ {m}_{x} ( \frac{\partial {H}_{z}}{\partial x} ) + {m}_{z} ( \frac{\partial {H}_{z}}{\partial z} ) \}}{\partial z} ] cos ( θ ) \\ + [ \frac{\partial \{ {m}_{x} ( \frac{\partial {H}_{x}}{\partial x} ) + {m}_{z} ( \frac{\partial {H}_{x}}{\partial z} ) \}}{\partial z} ] sin ( θ ) \\ = [ \frac{\partial \{ {m}_{x} ( \frac{\partial {H}_{x}}{\partial z} ) + {m}_{z} ( \frac{\partial {H}_{z}}{\partial z} ) \}}{\partial z} ] cos ( θ ) \\ + [ \frac{\partial \{ {m}_{x} ( \frac{\partial {H}_{x}}{\partial x} ) + {m}_{z} ( \frac{\partial {H}_{x}}{\partial z} ) \}}{\partial z} ] sin ( θ ) \\ = {m}_{x} \{ ( \frac{{\partial }^{2} {H}_{x}}{\partial {z}^{2}} ) cos ( θ ) + ( \frac{{\partial }^{2} {H}_{x}}{\partial x \partial z} ) sin ( θ ) \} \\ + {m}_{z} \{ ( \frac{{\partial }^{2} {H}_{z}}{\partial {z}^{2}} ) cos ( θ ) + ( \frac{{\partial }^{2} {H}_{x}}{\partial {z}^{2}} ) sin ( θ ) \} \\ = {m}_{0} sin ( ω t - {ϕ}_{04} ) \{ ( \frac{{\partial }^{2} {H}_{x}}{\partial {z}^{2}} ) cos ( θ ) + ( \frac{{\partial }^{2} {H}_{x}}{\partial x \partial z} ) sin ( θ ) \} \\ + {m}_{0} cos ( ω t - {ϕ}_{04} ) \{ ( \frac{{\partial }^{2} {H}_{z}}{\partial {z}^{2}} ) cos ( θ ) + ( \frac{{\partial }^{2} {H}_{x}}{\partial {z}^{2}} ) sin ( θ ) \} \\ = {m}_{0} \{ sin ( ω t ) cos ( - {ϕ}_{04} ) + cos ( ω t ) sin ( - {ϕ}_{04} ) \} \\ \{ ( \frac{{\partial }^{2} {H}_{x}}{\partial {z}^{2}} ) cos ( θ ) + ( \frac{{\partial }^{2} {H}_{x}}{\partial x \partial z} ) sin ( θ ) \} \\ + {m}_{0} \{ cos ( ω t ) cos ( - {ϕ}_{04} ) - sin ( ω t ) sin ( - {ϕ}_{04} ) \} \\ \{ ( \frac{{\partial }^{2} {H}_{z}}{\partial {z}^{2}} ) cos ( θ ) + ( \frac{{\partial }^{2} {H}_{x}}{\partial {z}^{2}} ) sin ( θ ) \} \\ = cos ( ω t ) [ {m}_{0} sin ( - {ϕ}_{04} ) \{ ( \frac{{\partial }^{2} {H}_{x}}{\partial {z}^{2}} ) cos ( θ ) + ( \frac{{\partial }^{2} {H}_{x}}{\partial x \partial z} ) sin ( θ ) \} \\ + {m}_{0 } cos ( - {ϕ}_{04} ) \{ ( \frac{{\partial }^{2} {H}_{z}}{\partial {z}^{2}} ) cos ( θ ) + ( \frac{{\partial }^{2} {H}_{x}}{\partial {z}^{2}} ) sin ( θ ) \} ] \\ + sin ( ω t ) [ {m}_{0} cos ( - {ϕ}_{04} ) \{ ( \frac{{\partial }^{2} {H}_{x}}{\partial {z}^{2}} ) cos ( θ ) + ( \frac{{\partial }^{2} {H}_{x}}{\partial x \partial z} ) sin ( θ ) \} \\ - {m}_{0 } sin ( - {ϕ}_{04} ) \{ ( \frac{{\partial }^{2} {H}_{z}}{\partial {z}^{2}} ) cos ( θ ) + ( \frac{{\partial }^{2} {H}_{x}}{\partial {z}^{2}} ) sin ( θ ) \} ]\end{matrix} \qquad ( 10 )$$

The synchronizing signal measured by the demodulated signal processing device 152 (lock-in amplifier) corresponds to:

m₀ sin(−φ₀₄){(∂²Hₓ/∂z²)cos(θ)+(∂²Hₓ/∂x∂z)sin(θ)}+m₀ cos(−φ₀₄){(∂²H_{z}/∂z²)cos(∂)+(∂²Hₓ/∂z²)sin(∂)}

The orthogonal signal measured by the demodulated signal processing device 152 (lock-in amplifier) corresponds to:

m₀ cos(−φ₀₄){(∂²Hₓ/∂z²)cos(θ)+(∂²Hₓ/∂x∂z)sin(θ)}−m₀ sin(−φ₀₄){(∂²H_{z}/∂z²)cos(∂)+(∂²Hₓ/∂z²)sin(∂)}

Therefore, as described above, when θ is small, the synchronizing signal measured by the demodulated signal processing device 152 (lock-in amplifier) corresponds to:

(∂²H_{z}/∂z²)cos(−φ₀₄)+(∂²Hₓ/∂z²)sin(−φ₀₄)

and the orthogonal signal measured by the lock-in amplifier corresponds to:

(∂²Hₓ/∂z²)cos(−φ₀₄)−(∂²H_{z}/∂z²)sin(−φ₀₄)

The scanning mechanism 16 scans the surface of the specimen 5 by means of the probe 111 of the cantilever 11 (S150). Its scanning speed is slow enough to be ignored when the demodulator 15 demodulates the alternating magnetic force.

While the scanning mechanism 16 scans the surface of the specimen 5 by means of the probe 111 in directions parallel to the surface of the specimen 5, The data storage 17 stores the following at each point of the scanning area of the probe as the initial data (S160):

the amplitude and delay angle of the demodulated signal (alternating magnetic force signal);

the synchronizing signal measured by the demodulated signal processing device 152 (lock-in amplifier); and

the orthogonal signal measured by the demodulated signal processing device 152 (lock-in amplifier).

A set of measurement process of S110 to S160 is carried out to a lot of positions on the surface of the specimen 5 (on the scanning area).

The demodulated signal (alternating magnetic force signal ∂F_{z}/∂z) is represented as below:

$$\begin{matrix}( \frac{\partial {F}_{2}}{\partial z} ) = {m}_{0} sin ( ω t - {ϕ}_{04} ) ( \frac{{\partial }^{2} {H}_{x}}{\partial {z}^{2}} ) + {m}_{0 } cos ( ω t - {ϕ}_{04} ) ( \frac{{\partial }^{2} {H}_{z}}{\partial {z}^{2}} ) \\ = {m}_{0} [ {\{ ( \frac{{\partial }^{2} {H}_{z}}{\partial {z}^{2}} ) cos ( - {ϕ}_{04} ) + ( \frac{{\partial }^{2} {H}_{x}}{\partial {z}^{2}} ) sin ( - {ϕ}_{04} ) \}}^{2} + \\ {{ ( \frac{{\partial }^{2} {H}_{x}}{\partial {z}^{2}} ) cos ( - {ϕ}_{04} ) - ( \frac{{\partial }^{2} {H}_{z}}{\partial {z}^{2}} ) sin ( - {ϕ}_{04} ) \}}^{2} ]}^{1 / 2} \\ cos ( ω t + {tan}^{- 1} ) [ \{ ( \frac{{\partial }^{2} {H}_{x}}{\partial {z}^{2}} ) cos ( - {ϕ}_{04} ) - ( \frac{{\partial }^{2} {H}_{z}}{\partial {z}^{2}} ) sin ( - {ϕ}_{04} ) \} / \\ \{ ( \frac{{\partial }^{2} {H}_{z}}{\partial {z}^{2}} ) cos ( - {ϕ}_{04} ) + ( \frac{{\partial }^{2} {H}_{x}}{\partial {z}^{2}} ) sin ( - {ϕ}_{04} ) \} ] ) \\ = {m}_{0} [ \{ ( \frac{{\partial }^{2} {H}_{z}}{\partial {z}^{2}} ) cos ( - {ϕ}_{04} ) + ( \frac{{\partial }^{2} {H}_{x}}{\partial {z}^{2}} ) {sin ( - {ϕ}_{04} )}^{2} + \\ { {\{ ( \frac{{\partial }^{2} {H}_{x}}{\partial {z}^{2}} ) cos ( - {ϕ}_{04} ) - ( \frac{{\partial }^{2} {H}_{z}}{\partial {z}^{2}} ) sin ( - {ϕ}_{04} ) \}}^{2} ]}^{1 / 2} \\ cos ( ω t - {tan}^{- 1} ) [ \{ ( \frac{{\partial }^{2} {H}_{z}}{\partial {z}^{2}} ) sin ( - {ϕ}_{04} ) - ( \frac{{\partial }^{2} {H}_{x}}{\partial {z}^{2}} ) cos ( - {ϕ}_{04} ) \} / \\ \{ ( \frac{{\partial }^{2} {H}_{z}}{\partial {z}^{2}} ) cos ( - {ϕ}_{04} ) + ( \frac{{\partial }^{2} {H}_{x}}{\partial {z}^{2}} ) sin ( - {ϕ}_{04} ) \} ] )\end{matrix}$$

Therefore, the amplitude of the alternating magnetic force signal (∂F_{z}/∂z) is represented as below:

=m₀[{(∂²H_{z}/∂z²)cos(−φ₀₄)+(∂²Hₓ/∂z²)sin(−φ₄₀)}²+{(∂²Hₓ/∂z²)cos(−φ₀₄)−(∂²H_{z}/∂z²)sin(−φ₀₄)}²]^{1/2}

Also, the delay angle of the alternating magnetic force signal (∂F_{z}/∂z) is represented as below:

φ₀₃=tan⁻¹[{∂²H_{z}/∂z²} sin(−ω₀₄)−(∂²Hₓ/∂z²)cos(−φ₀₄)}/{(∂²H_{z}/∂z²)cos(−φ₀₄)+(∂²Hₓ/∂z²)sin(−φ₀₄)}]

The synchronizing signal measured by the demodulated signal processing device 152 (lock-in amplifier) is represented as below:

(∂²H_{z}/∂z²)m₀ cos(−φ₀₄)+(∂²H_{z}/z²)m₀ sin(−φ₀₄)

The orthogonal signal measured by the demodulated signal processing device 152 (lock-in amplifier) is represented as below:

(∂²Hₓ/∂z²)m₀ cos(−φ₀₄)−(∂²H_{z}/∂z²)m₀ sin(−φ₀₄)

The modulated data generator 18 recalls

(a) the amplitude and delay angle φ₀₃ of the initial data (∂F_{z}/∂z),
(b) the synchronizing signal and the orthogonal signal

(∂²H_{z}/∂z²)m₀ cos(−φ₀₄)+(∂²Hₓ/∂z²)m₀ sin(−φ₀₄),

(∂²Hₓ/∂z²)m₀ cos(−φ₀₄)−(∂²H_{z}/∂z²)m₀ sin(−φ₀₄)

which are stored in the data storage 17, and generates a lot of data by modifying (increasing or decreasing) the phase φ of the initial data (S170).

The image display device 19 displays an image of magnetic field distribution according to the initial data stored in the data storage 17 and an image of magnetic field distribution according to the data in which the phase φ of the initial data has been modified for each coordinate of the scanning area (S180).

For example, range of brightness (density or luminance) is supposed to have 2N+1 steps from 0 that is the minimum to 2N (N is a positive integer) that is the maximum. Defining the brightness as “2N” when the intensity of the magnetic field is maximum upward, as “N” when the intensity of the magnetic field is zero, and as “0” when the intensity of the magnetic field is maximum downward, and allocating the 2N+1 steps of the brightness to the intensity of the magnetic field including direction, the image of magnetic field distribution is generated.

By observing the image of magnetic field distribution visually or by software, it is possible to obtain the magnetic profile (in specific, magnetization state) of the specimen 5 (S190).

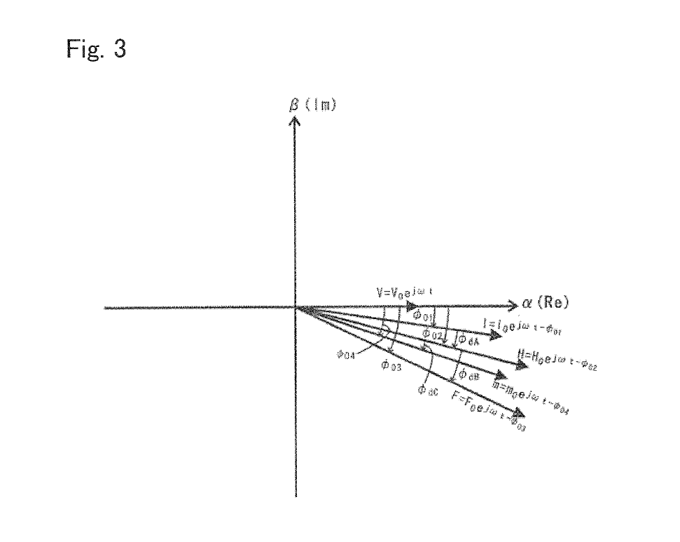

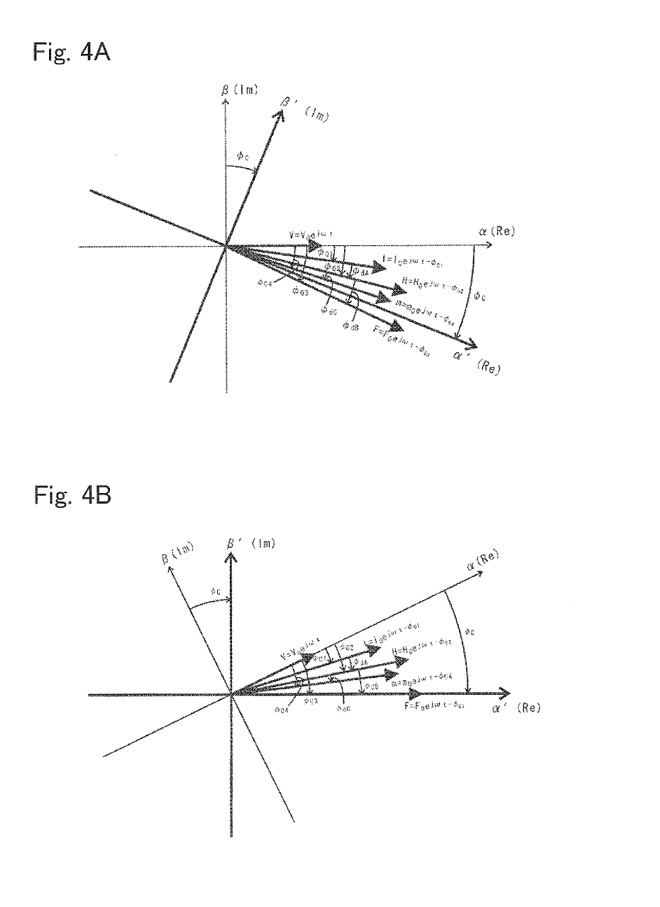

FIGS. 3 and 4 are figures for supplemental explanation illustrating the process described above.

A vector diagram shown by α-β coordinate system in FIG. 3 shows a phase before a process by means of the modified data generator 18 is carried out.

In FIG. 3, a magnetic force gradient vector is represented by Formula (11):

α₁+jβ₁={(∂²H_{z}/∂z²)cos(−φ₀₄)+(∂²Hₓ/∂z²)sin(−φ₀₄)}+j{(∂²Hₓ/∂z²)cos(−φ₀₄)−(∂²H_{z}/∂z²)sin(−φ₀₄)}

that is,

α₁=(∂²H_{z}/∂z²)cos(−φ₀₄)+(∂²Hₓ/∂z²)sin(−φ₀₄)

β₁=−(∂²H_{z}/∂z²)sin(−φ₀₄)+(∂²Hₓ/∂z²)cos(−φ₀₄) (11)

A vector diagram shown by α′-β′ coordinate system in FIG. 4A is a diagram in which the α-β coordinate system in FIG. 3 is rotated, and the modified data generator 18 adjusts the initial phase to zero by adding a correction phase φ_{C} to the phase −φ₀₄ in Formula (11).

In the α′-β′ coordinate system, the magnetic force gradient vector in the same direction as the magnetization m vector of the probe 111 is represented by Formula (12):

α₁′+jβ₁: {(∂²H_{z}/z²)cos(−₀₄+φc)+(e²Hₓ/∂z²)sin(−φ₀₄+φ_{C})}+j{−(∂²H_{z}/∂z²)sin(−φ₀₄+φ_{C})+(∂²Hₓ/∂z²)cos(−φ₀₄+φ_{C})}

that is,

α₁′=(∂²H_{z}/∂z²)cos(−φ₀₄+φ_{C})+(∂²Hₓ/∂z²)sin(−φ₀₄+φ_{C})

β₁′=−(∂²H_{z}/∂z²)sin(−φ₀₄+φ_{C})+(∂²Hₓ/∂z²)cos(−φ₀₄+φ_{C}) (12)

Therefore, as shown in FIG. 4B, the condition for the initial phase of the magnetic force gradient vector to be zero in the α-β′ coordinate system is represented by Formula (13):

φ_{C}=φ₀₄ (13)

In this case, α₁′ corresponds only to a perpendicular magnetic field gradient:

α₁′=(∂²H_{z}/∂z²)

Further, when the phase is shifted forward by 90° as φ_{C}=φ₀₄+90°, α₁′ corresponds only to an in-plane magnetic field gradient.

α₁′=(∂²Hₓ/∂z₂)

An operator can obtain the condition of Formula (13), without using the modified data generator 18, by: firstly, generating an image of magnetic field distribution of the phase φ₀₄ from the initial data stored in the data storage 17; then modifying the correction phase φ_{C} while visually observing the image (or, modifying the correction phase φ_{C} while observing the image of the magnetic field distribution by software, and finding out an image having maximum brightness (or an image having minimum brightness). Here, as the correction of φ₀₄, by using an specimen having a known magnetization state such as a perpendicular magnetic recording medium having a low recording density as a standard specimen and adjusting the phase at a position where only a perpendicular magnetic field or a position where only an in-plane magnetic field occurs, it is possible to measure a magnetic profile with a high accuracy.

In the above example, a phase of the magnetic field H at the position of the probe 111 is identified by finding out an image having maximum brightness (or an image having minimum brightness). However, it is also possible to identify the phase (and amplitude) of the magnetic field at the position of the probe 111 by finding out an image of magnetic field distribution having maximum brightness difference, or by finding out an image of magnetic field distribution having minimum brightness difference.

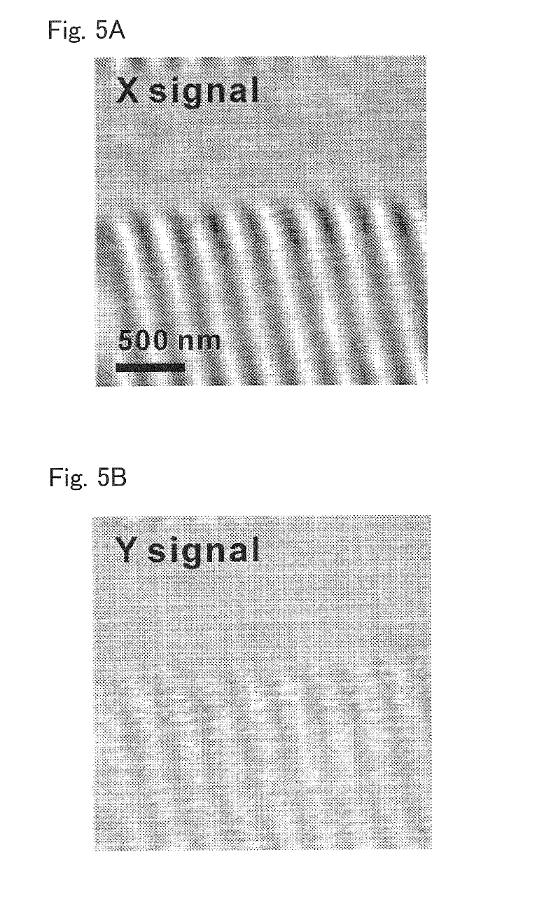

FIGS. 5A and 5B show respective examples of an image of perpendicular magnetic field distribution and an image of in-plane magnetic field distribution on a surface of a hard disc having indefinite phase, stored in the data storage 17.

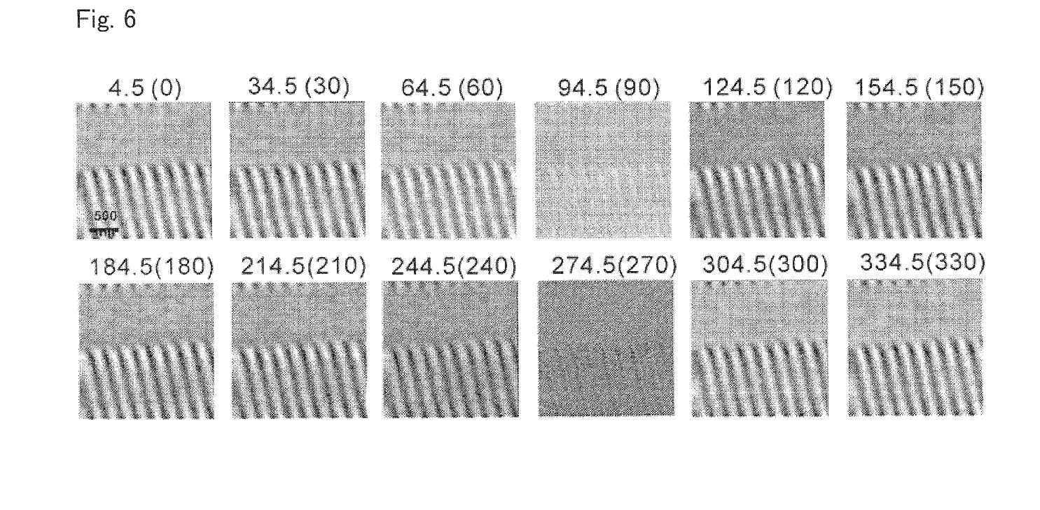

FIG. 6 shows examples of images of magnetic field distribution on the surface of the hard disk with their phases modified, wherein the images have been generated from the images of FIGS. 5A and 5B (data stored in the data storage 17).

FIG. 6 shows twelve images of magnetic field distribution corresponding to component of a′ coordinate with their phases being modified stepwise by 30° per each, after adjusting the phase so that the phase becomes zero when magnetic intensity becomes maximum at a central portion of recording bit of a perpendicular magnetic recording medium (only a perpendicular magnetic field occurs) that is a specimen. For each of the images of magnetic field distribution, phase values are noted. Phases based on the phase of the alternating voltage V (see Formula (1)) are noted, and phases in the above-described α′-β′-coordinate system are noted in parentheses.

As described above, an image of perpendicular magnetic field and an image of in-plane magnetic field can be obtained by modifying the correction phase (φ_{C}) while visually observing the images of magnetic field distribution displayed in the image display device 19 (or, modifying the correction phase (φ_{C}) while observing the images of magnetic field distribution by software). In FIG. 6, the phase with which an image of perpendicular magnetic field can be obtained is 4.5°, and the phase in the α′-β′ coordinate system such that the correction angle becomes −4.5° is shown in each parenthesis.

Images with phase difference described in parentheses of 0° and 180° correspond to images of perpendicular magnetic field, and images with phase difference described in parentheses of 90° and 270° correspond to images of in-plane magnetic field.

### DESCRIPTION OF THE REFERENCE NUMERALS

1 magnetic profile measuring device
5, 82, 93 specimen
11, 81, 91 cantilever
12 driver
13, 92 alternating-current magnetic field generator
14 vibration sensor
15 demodulator
16 scanning mechanism
17 data storage
18 modified data generator
19 image display device
111, 811, 911 probe
121, 812, 912 piezoelectric element
122 power source
131 signal generator
132 coil main body
141 laser
142 photodiode
151 alternating magnetic force signal demodulator
152 demodulated signal processing device

1. A magnetic profile measuring device which scans a scanning area on a surface of a specimen by means of a magnetized probe on a tip of a driven cantilever, detects vibration of the cantilever, and generates an image of magnetic field distribution of the scanning area based on results of the detection, the device comprising:
the cantilever wherein the probe is equipped on the tip of the cantilever;
a driver driving the cantilever at a resonant frequency of the cantilever or at a frequency close to the resonant frequency of the cantilever;
an alternating-current magnetic field generator generating an alternating-current magnetic field and periodically reversing the magnetic polarity of the probe, and thereby modulating driven vibration of the cantilever by frequency or by both frequency and amplitude;
a vibration sensor detecting vibration of the probe;
a demodulator demodulating from a detection signal of the vibration sensor a magnetic signal which corresponds to an alternating-current magnetic force occurring between the probe and the specimen, and detecting the demodulated magnetic signal as (A) two separate signal components having phase difference of 90° and being orthogonal to each other or (B) amplitude and a phase of the magnetic field at the position of the probe;
a scanning mechanism scanning the scanning area by means of the probe;
a data storage storing an initial data for each coordinate of the scanning area wherein the initial data is (A) the two separate signal components orthogonal to each other or (B) the amplitude and phase of the magnetic field, and wherein the initial data is obtained by scanning the scanning area by means of the scanning mechanism on condition that the demodulation is synchronized with operation of the alternating-current magnetic field generator;
a modified data generator recalling the initial data from the data storage and generating a plurality of data by modifying the phase of the initial data; and
an image display device displaying an image of magnetic field distribution based on data generated for each coordinate of the scanning area by the modified data generator.

2. The magnetic profile measuring device according to claim 1, wherein
where the magnetic field at the position of the probe is represented by
H_{α}+jH_{β}≡H₀exp(jφ)
in α-β complex plane which is Gauss plane;
amplitude of the magnetic field at the position of the probe, H₀, is represented by
H₀≡(H_{α}²+H_{β}²)^{1/2}
which is a distance from the origin in the α-β complex plane;
the phase of the magnetic field at the position of the probe, φ, is represented by
φ≡tan⁻¹(H_{β}/H_{α})
which is an argument φ in the α-β complex plane;
α-component of the magnetic field at the position of the probe is represented by
H_{α}=H₀ cosφ
which is a component parallel to the α-axis; and
β-component of the magnetic field at the position of the probe is represented by
H_{β}=H₀ cosφ
which is a component parallel to the β-axis perpendicular to the α-axis,
the demodulator detects the demodulated magnetic signal as (A) a data pair of the α-component and the β-component (H_{α}, H_{β}) or (B) a data pair of the amplitude and the phase (H₀, φ).

3. The magnetic profile measuring device according to claim 2, wherein
either (X) the α-component is a perpendicular magnetic field component of the magnetic field wherein the perpendicular magnetic field component is a component perpendicular to the surface of the specimen; and the β-component is an in-plane magnetic field component of the magnetic field wherein the in-plane magnetic field component is a component parallel to the surface of the specimen,
or (Y) the α-component is an in-plane magnetic field component of the magnetic field wherein the in-plane magnetic field component is a component parallel to the surface of the specimen; and the β-component is a perpendicular magnetic field component of the magnetic field wherein the perpendicular magnetic field component is a component perpendicular to the surface of the specimen.

4. The magnetic profile measuring device according to claim 2,
wherein the magnetic field at the position of the probe is displayed by means of the image display device by making the α-component and/or the β-component into an image depending on variation of the argument φ.

5. A method for measuring magnetic profile including scanning a scanning area on a surface of a specimen by means of a magnetized probe on a tip of a driven cantilever, detecting vibration of the cantilever, and generating an image of magnetic field distribution of the scanning area based on results of the detection, the method comprising the steps of:
driving the cantilever at a resonant frequency of the cantilever or at a frequency close to the resonant frequency of the cantilever, wherein the probe is equipped on the tip of the cantilever (S110);
generating an alternating-current magnetic field and periodically reversing the magnetic polarity of the probe, and thereby modulating driven vibration of the cantilever by frequency (S120);
detecting vibration of the probe and demodulating from the detection signal a magnetic signal which corresponds to an alternating-current magnetic force occurring between the probe and the specimen (S130);
detecting the demodulated magnetic signal as (A) two separate signal components which have phase difference of 90° and are orthogonal to each other or (B) amplitude and a phase of the magnetic field at the position of the probe (S140);
scanning the scanning area by means of the probe (S150);
storing an initial data in a data storage for each coordinate of the scanning area wherein the initial data is (A) the two separate signal components orthogonal to each other or (B) the amplitude and phase of the magnetic field, and wherein the initial data is obtained by scanning the scanning area on condition that the demodulation is synchronized with the generation of the alternating-current magnetic field (S160);
recalling the initial data from the data storage and generating a plurality of data by modifying the phase of the initial data (S170);
displaying an image of a magnetic field distribution based on data generated by modifying the phase of the initial data, on a image display device (S180); and
measuring the magnetic profile of the specimen based on each image of magnetic field distribution displayed on the image display device (S190).

6. The method for measuring magnetic profile according to claim 5, wherein in the step of detecting the demodulated magnetic signal (S140),
where the magnetic field at the position of the probe is represented by
H_{α}+jH_{β}≡H₀exp(jφ)
in α-β complex plane which is Gauss plane;
amplitude of the magnetic field at the position of the probe, H₀, is represented by
H₀≡(H_{α}²+H_{β}²)^{1/2}
which is a distance from the origin in the α-β complex plane;
the phase of the magnetic field at the position of the probe, φ, is represented by
φ≡tan⁻¹(H_{β}/H_{α})
which is an argument φ in the α-β complex plane;
α-component of the magnetic field at the position of the probe is represented by
H_{α}=H₀ cosφ
which is a component parallel to the α-axis; and
β-component of the magnetic field at the position of the probe is represented by
H_{β}=H₀ cosφ
which is a component parallel to the β-axis perpendicular to the α-axis,
the demodulated magnetic signal is detected as (A) a data pair of the α-component and the β-component (H_{α}, H_{β}) or (B) a data pair of the amplitude and the phase (H₀, φ).

7. The method for measuring magnetic profile according to claim 6, wherein
either (X) the α-component is a perpendicular magnetic field component of the magnetic field wherein the perpendicular magnetic field component is a component perpendicular to the surface of the specimen; and the β-component is an in-plane magnetic field component of the magnetic field wherein the in-plane magnetic field component is a component parallel to the surface of the specimen,
or (Y) the α-component is an in-plane magnetic field component of the magnetic field wherein the in-plane magnetic field component is a component parallel to the surface of the specimen; and the β-component is a perpendicular magnetic field component of the magnetic field wherein the perpendicular magnetic field component is a component perpendicular to the surface of the specimen.

8. The method for measuring magnetic profile according to claim 6,
wherein the magnetic field at the position of the probe is displayed by means of the image display device by making the α-component and/or the β-component into an image depending on variation of the argument φ.

9. The magnetic profile measuring device according to claim 3,
wherein the magnetic field at the position of the probe is displayed by means of the image display device by making the α-component and/or the β-component into an image depending on variation of the argument φ.

10. The method for measuring magnetic profile according to claim 7,
wherein the magnetic field at the position of the probe is displayed by means of the image display device by making the α-component and/or the β-component into an image depending on variation of the argument φ.
